(19) United States
(12) Patent Application Publication
(10) Pub. No.: US 2007/0097898 A1
(43) Pub. Date: May 3, 2007

(54) Automatic switching system expanding the service range of an access point and method for the same

(76) Inventor: Sheng-Kai Juang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/261,461

(22) Filed: Oct. 31, 2005

(51) Int. Cl. H04J 1/10; H04B 7/14; H04J 3/08

(52) U.S. Cl. 370/315

(57) ABSTRACT

An automatic switching system that expands the service range of an access point and method for the same, operating on an information processing platform provided with a WLAN card, comprising a detect module to determine whether the card is left unused, a software module providing a suite of WLAN repeater software and a suite of WLAN card software, and a switching module switching the software used by the card to the WLAN repeater software or the WLAN card software according to a result given by the detect module. When the detect module determines that the platform is executing the application program that provides the network service, the switching module switches the WLAN card to use the card software, and when the detect module determines the platform does not execute the application program that provides the network service, the switching module switches the WLAN card to use the repeater software.

### BACKGROUND OF THE INVENTION

1. Field of the Invention

This invention relates to an automatic switching system expanding the service range of an AP and method for the same and particularly to an automatic switching system that expands the service range of an AP through a WLAN card and method for the same.

2. Description of Related Art

It forms a WLAN (Wireless Local Area Network) that a computer connects to an access point (AP) through a wireless LAN card for implementing wireless local networking, thereby accessing network resources. In the structure of WLAN, an AP must be installed at a node of the WLAN and a WLAN card must be provided in client equipment, such as a computer, so that wireless Internet access may be achieved through the AP and the WLAN card.

The service of current AP to the client equipment is in a range of only hundreds of meters; as shown in FIG. 1, in the service range 81 of AP, all the sets of client equipment, such as computers 71, 72, and 73 may connect with each other through the WLAN card (not shown) and the AP 70, while far from the service range 81 of AP 70, the sets of client equipment as a computer 74 and a PDA 75 cannot connect with each other through the WLAN card and the AP 70. Further, it is subject to shields, such as walls or windows, and thus the range of service of the AP 70 to the computers may be reduced to tens of meters.

In order to expand the service range of AP, currently, installation of dense APs or repeaters may be implemented, as shown in FIG. 2 for installation of the wireless LAN repeater 76 in the WLAN. The repeater 76 may expand the service range 81 of AP 70 into a service range 82, making the computer 74 and the PDA 75 communicate with the AP 70 wirelessly.

Regardless of the dense APs or repeaters installed to expand the service range of AP, the prime cost of APs, repeaters, and layout significantly increases and the loading of manpower maintenance is heavy. Thus, to build a wider WLAN, decrease the cost, and lower the load of maintenance are tasks to be dealt with.

### SUMMARY OF THE INVENTION

Technical tasks to be dealt with according to this invention lies in a switching system that expands the service range of an AP and method for the same, by using a WLAN card left unused to automatically switch to the function of a repeater, for expanding the service range of AP.

In order to solve the technical problem, according to an embodiment of this invention, the switching system expanding the service range of an AP, which operates on an information processing platform provided with a WLAN card, comprising a detect module that is used to determine whether the platform executes an application program providing a network service. A software module is provided with a suite of software for the repeater and a suite of software for the WLAN card. According to the results given from the detect module, a switching module switches the WLAN card to use the repeater software or the WLAN card software. Accordingly, when the detect module determines that the information processing platform is executing the application program that provides the network service, the switching module switches the WLAN card to use the WLAN card software, and when the detect module determines the platform does not execute the application program that provides the network service, the switching module switches the WLAN card to use the repeater software, making the card automatically switches to the repeater.

In order to solve the technical problem, according to another embodiment of this invention, a method of automatic switching to expand the service range of AP is provided, which operates on an information processing platform provided with a WLAN card, in which the platform is in the service range of AP, comprising providing the WLAN card software and the WLAN repeater software for the WLAN card to use; determining whether the information processing platform is executing an application program providing the network service; switching a suite of software used by the card to the WLAN card software, when the detection result is correct, so that the WLAN card may be used to connect with the AP; switching the suite of software used by the card to the WLAN repeater software, when the detection result is not correct, so that the WLAN card may be used to expand the service range of AP.

The switching system that expands the service range of AP and method for the same according to this invention is used to expand the service range of AP, thereby large amounts of APs and WLAN repeaters being unnecessary and then making it possible to reduce the cost of WLAN layout.

### BRIEF DESCRIPTION OF THE DRAWINGS

FIG. 1 is a schematic view illustrating the service range of a conventional access point (AP);

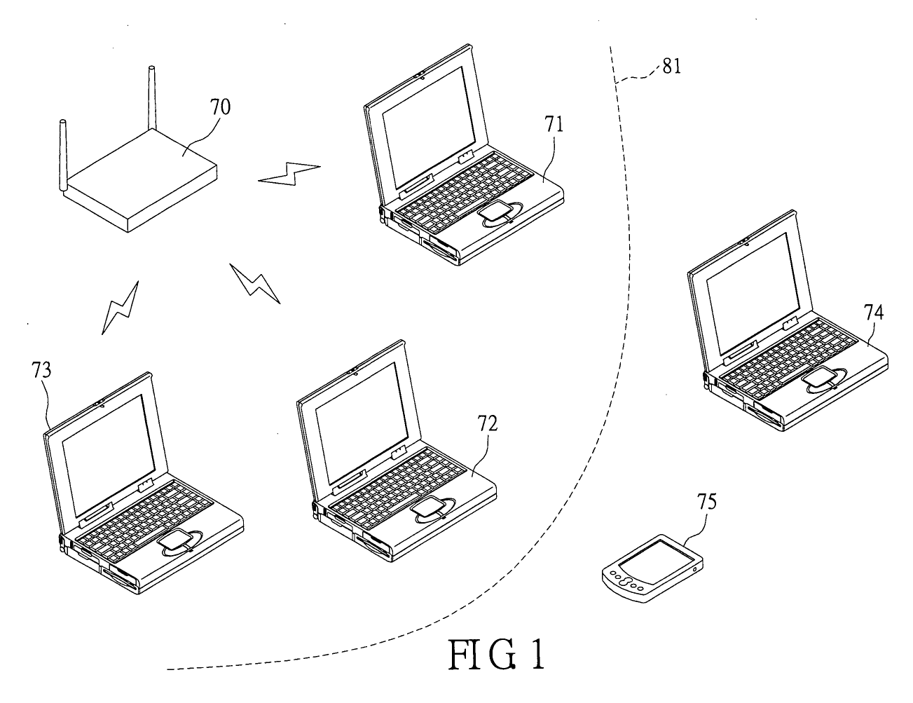

FIG. 2 is a schematic view illustrating the expansion of service range of the conventional AP by means of a WLAN repeater;

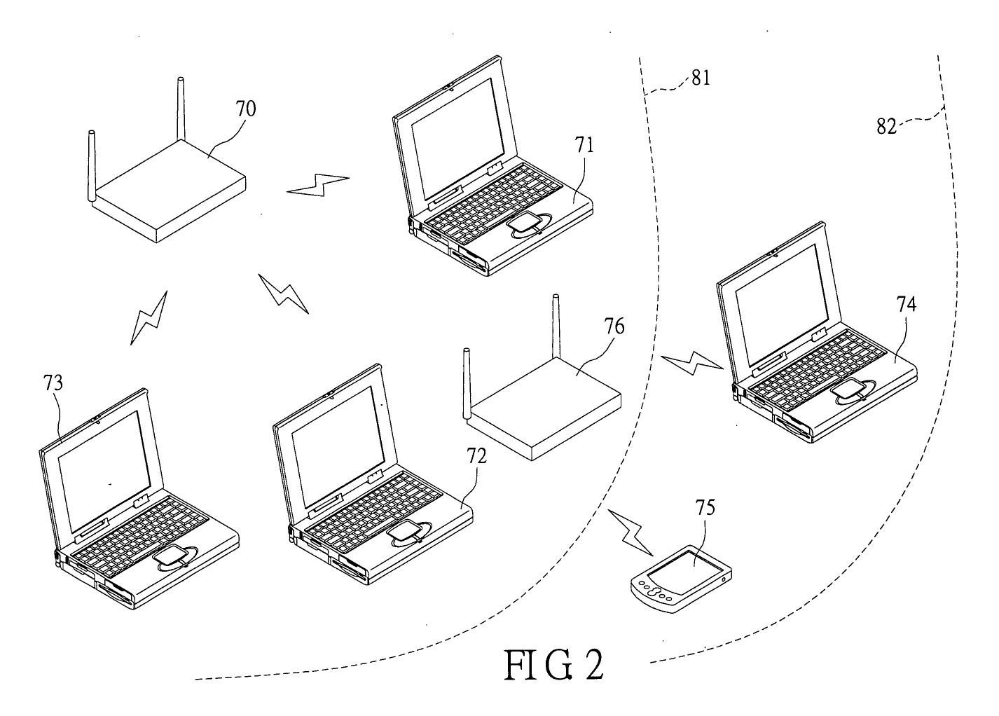

FIG. 3 is a view of a system structure of one of the preferred embodiments of this invention;

FIG. 4 is a flow chart of one of the preferred embodiments of this invention; and

FIG. 5 is a schematic view illustrating the expansion of service range of the AP according to this invention.

### DETAILED DESCRIPTION OF THE PREFERRED EMBODIMENTS

This invention provides an automatic switching system that expands the service range of an access point (AP) and method for the same. An AP, a WLAN card, and a WLAN repeater in a hardware structure are formed mainly with a media access controller (MAC), a base band controller, and a RF module (controller); however, the services provided are different from each other in that suits of software used are different; namely, by means of different software, the AP may serve as a WLAN card or the WLAN card may also serve as a WLAN repeater. In this invention, by means of different software, the WLAN card may be switched to or from the WLAN repeater to function. Thus, when the WLAN card is in the range of service of the AP, the service range of the AP may be expanded when the WLAN card switches to the WLAN repeater to function.

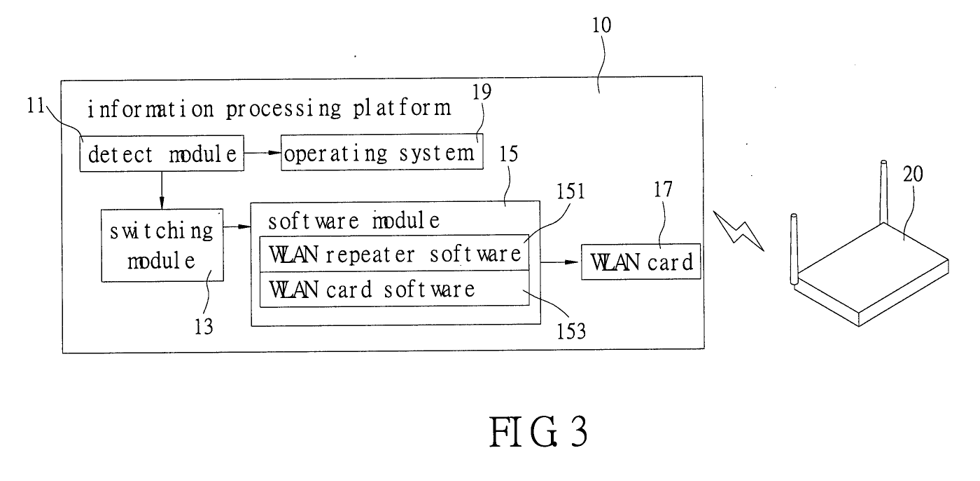

Refer now to FIG. 3 for a system structure of one of the preferred embodiments of this invention. In the embodiment, an information processing platform 10 is provided with a WLAN card 17 and may connect with an AP 20 through the WLAN card 17, in which the platform 10 may be a computer, a PDA, or a set of equivalent equipment. On the platform 10, the software is upgraded to provide the WLAN card 17 an automatic switching system, making the card 17 may automatically switch to or from the WLAN repeater depending on a practical operating condition.

In this embodiment, the automatic switching system comprises a detect module 11, a switching module 13, and a software module 15, in which the detect module 11 functions to determine whether an operating system 19 in the information processing platform 10 is executing the application program providing network service, in which the application program may be web browser software, e-mailing software, or another software required for the WLAN card; a WLAN card 17 left unused may be found according to a result given from the module 11. Depending on a result given by the detect module 11, the switching module 13 switches the software used by the WLAN card 17. The software used by the WLAN card 17 is provided by the software module 15 and may be a suite of WLAN repeater software 151 or a suite of WLAN card software 153. When the WLAN card 17 uses the WLAN repeater software 151, the card 17 executes the function of repeater, while when the card 17 uses the WLAN card software 153, the card 17 executes the function of card.

In the embodiment, the software used by the card 17 that is left unused, namely, not operated by a user to wirelessly access to Internet, is used to switch the card 17 to the repeater for expansion of service range of AP 20, when the user want to wirelessly access to Internet through the card 17, the software used by the WLAN card 17 is switched to the function of the WLAN card. Thus, when the detect module 11 determines that the information processing platform 10 is executing the application program that provides the network service, the switching module 13 switches the WLAN card 17 to the WLAN card software 153. When the detect module 11 determines that the information processing platform 10 does not execute the application program that provides the network service, the switching module 13 switches the WLAN card 17 to the WLAN repeater software 151. To sum up, in the embodiment, the software used by the WLAN card 17 may switches automatically so that the WLAN card 17 may automatically switch to or from the WLAN repeater to function.

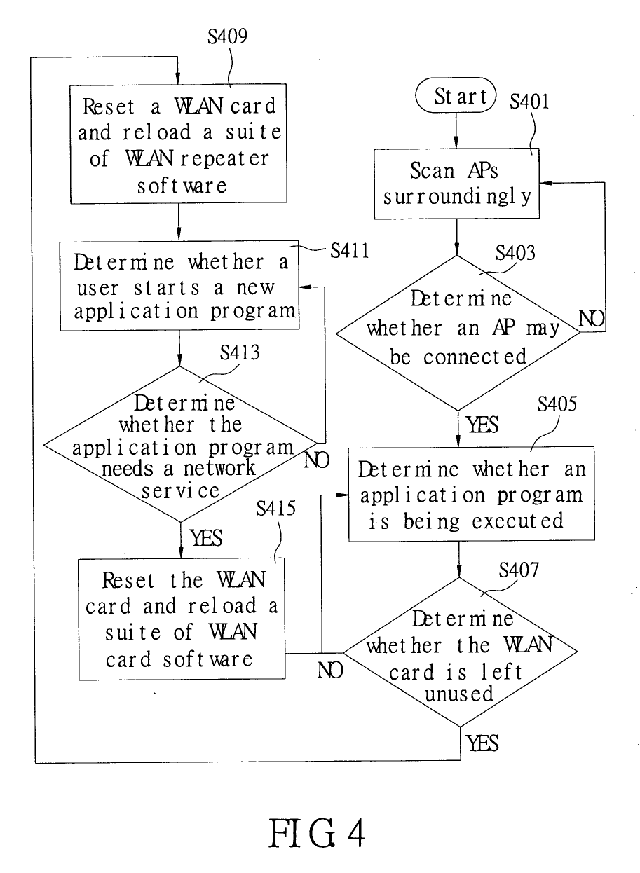

Refer now to FIG. 4 for a flow chart of one of the preferred embodiments of this invention. When being booted, the platform 10 scans the AP (S401) surrounding through the WLAN card 17, in which the card 17 as defaulted uses the WLAN card software 153; then, it determines whether the card 17 may connect to the AP 20 (step S403); if the result is No, go back to step S401; if the result is Yes, it indicates that the WLAN card 17 is in the service range of AP 20, further check if the platform 10 is executing an application program (S405); according to step S405, check if the card 17 is left unused (S407), in which at the step, the detect module 11 may determine whether the platform 10 is executing an application program that provides a network service and “the WLAN card 17 left unused” means that no connection to any AP 20 for wireless access to Internet; namely, the platform 10 does not execute the application program that provides the network service.

If the result is No at step S407, go back to step S405 to continue. If the result is Yes at step S407, reset the WLAN card 17 and the switching module 13 automatically switches to reload the WLAN repeater software 151 for the WLAN card 17 to use (S409), then the WLAN card 17 switches to the WLAN repeater to function. Next, go on to check if a user starts a new application program (S411); according to step S411, further determine whether the application program needs a network service (S413), and at this step the detect module 11 may determine the information processing platform 10 is executing the application program that provides the network service; if the result is No, go back to step S411 to continue, while if the result is Yes, reset the WLAN card 17 and the switching module 13 automatically switches to reload the WLAN card software 153 for the WLAN card 17 to use (S415); at this time, the WLAN card 17 is switched back to the function of the WLAN card, and go back to step S405 to continue.

In a flow chart of the embodiment of FIG. 4, when the WLAN card 17 is left unused, the switching module 13 may automatically switch the software used by the card 17 to the WLAN repeater software 151 from the WLAN card software 153 so that the card 17 switches to the WLAN repeater to function, thereby the service range of AP 20 being expanded. When the card 17 switches to the WLAN repeater to function, as long as the platform 10 starts to execute the application program that provides the network service, the switching module 13 still may automatically switch the WLAN repeater software 151 currently used by the WLAN card 17 to the WLAN card software 153, making the WLAN card 17 switches back.

Additionally, when using the WLAN card software 153, in order to prevent the card 17 from being temporarily left unused, the WLAN card 17 is switched to the WLAN repeater to function, which may be solved by determining whether the card 17 is left unused for more than a specified time. If the card 17 is left unused for more than a specified time, the detect module 11 is used to determine whether the platform executes the application program providing the network service in order to switch the card 17 to the WLAN repeater to function.

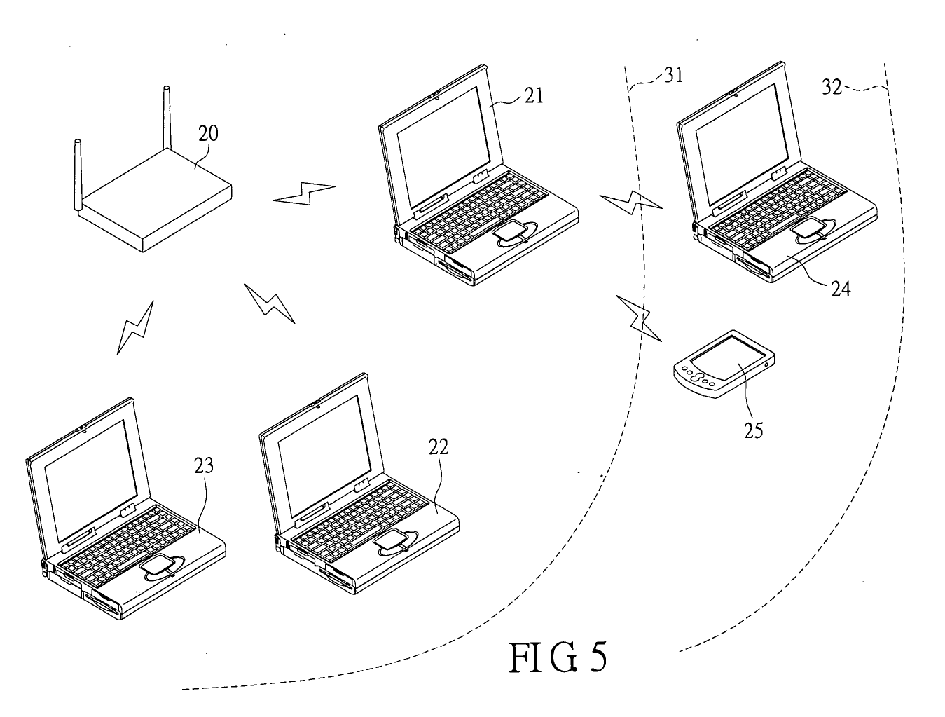

Refer now to FIG. 5 for illustration of the expansion of service range of the AP according to this invention. The computers 21, 22, and 23 are in the range 31 of service that the AP 20 may provide, while the computer 24 and the PDA 25 are far from the range 31 of service that the AP 20 may provide. The computers 21, 22, and 23 are provided with the automatic switching system used in the embodiment to expand the service range of AP. In FIG. 5, the WLAN card (not shown) used by the computer 21 is left unused and automatically switched to the WLAN repeater to function. Thus, the service range 31 of AP 20 may be expanded into the service range 32 so that the computer 24 and the PDA 25 may connect with the AP 20.

To sum up, the automatic switching system that expands the service range of an access point and method for the same according to this invention is featured with:
1. expansion of the service range of AP by means of the WLAN card left unused in the condition of no increase of APs or WLAN repeaters. making it possible to reduce the cost of WLAN layout and the load of manpower maintenance.
2. a function to make the WLAN card automatically switch to or from the WLAN repeater without manpower aid.

However, in the description mentioned above, only the preferred embodiments according to this invention are provided without limit to this invention and the characteristics of this invention; all those skilled in the art without exception should include the equivalent changes and modifications as falling within the true scope and spirit of the present invention.

What is claimed is:

1. An automatic switching system expanding the service range of an access point (AP), operating on an information processing platform provided with a wireless LAN (WLAN) card, comprising:
a detect module determining whether the platform executes an application program providing a network service;
a software module provided with a suite of WLAN repeater software and a suite of WLAN card software; and
a switching module switching to one of the repeater software and the WLAN card software for the WLAN card to use, according to the results given from the detect module,
in which when the detect module determines that the information processing platform is executing the application program that provides the network service, the switching module switches the WLAN card to use the WLAN card software, and when the detect module determines the platform does not execute the application program that provides the network service, the switching module switches the software module to the WLAN repeater software for the WLAN card to use.

2. The automatic switching system expanding the service range of an AP according to claim 1, wherein the information processing platform is a computer or a PDA.

3. The automatic switching system expanding the service range of an AP according to claim 1, wherein before the switching module switches to one of the WLAN repeater software and the WLAN card software for the WLAN card to use, the WLAN card must be reset.

4. A method of expanding the service range of an AP, operating on an information processing platform provided with a WLAN card that is in the service range of the AP, comprising:
providing a suite of WLAN repeater software and a suite of WLAN card software for the WLAN card to use;
determining whether the information processing platform is executing an application program providing a network service;
when the detection result is Yes, the software used by the WLAN card switches to the WLAN card software to connect with the AP; and
when the detection result is No, the software used by the WLAN card switches to the WLAN repeater software to expand the service range of AP.

5. The method of expanding the service range of an AP according to claim 4, wherein the information processing platform is a computer or a PDA.

6. The method of expanding the service range of an AP according to claim 4, wherein before the WLAN card switches to the WLAN card software, the WLAN card must be reset.

7. The method of expanding the service range of an AP according to claim 4, wherein before the WLAN card switches to the WLAN repeater software, the WLAN card must be reset.

8. A method of expanding the service range of an AP, operating on an information processing platform provided with a WLAN card that is in the service range of the AP, comprising:
providing a suite of WLAN repeater software and a suite of WLAN card software for the WLAN card to use;
using the WLAN card software in the WLAN card to connect with the AP;
determining whether the information processing platform is executing an application program providing a network service;
when the detection result is Yes, using the WLAN card software in the WLAN card; and
when the detection result is No, the software used by the WLAN card switches to the WLAN repeater software to expand the service range of AP.

9. The method of expanding the service range of an AP according to claim 8, wherein the information processing platform is a computer or a PDA.

10. The method of expanding the service range of an AP according to claim 8, wherein the step of detection is executed when the WLAN card is left unused for more than a specified time.

11. The method of expanding the service range of an AP according to claim 10, wherein the WLAN card is left unused because the card does not connect with the AP for wireless access to Internet.

12. The method of expanding the service range of an AP according to claim 8, wherein before the WLAN card switches to the WLAN repeater software, the WLAN card must be reset.

13. The method of expanding the service range of an AP according to claim 8, further comprising:
when the software used by the WLAN card is the WLAN repeater software, if the information processing platform starts to execute the application program that provides the network service, the software used by the WLAN card switches to the WLAN card software.
